(19) United States
(12) Patent Application Publication
(10) Pub. No.: US 2026/0352530 A1
(43) Pub. Date: Nov. 5, 2026

(54) ADAPTIVE AND DISTRIBUTED REFERENCE SIGNAL INSERTION IN DISCREET FOURIER TRANSFORM-SPREAD-ORTHOGONAL FREQUENCY DIVISION MULTIPLEXING (DFT-S-OFDM) SIGNALS

(71) Applicant: InterDigital Patent Holdings, Inc., Wilmington, DE (US)

(72) Inventors: Hussain Elkotby, Conshohocken, PA (US); Javier Lorca Hernando, Madrid (ES); Ravikumar Pragada, Warrington, PA (US); Ahmet Serdar Tan, London (GB); Pascal Adjakple, Great Neck, NY (US); Onur Sahin, London (GB); Sanjay Goyal, Deer Park, NY (US)

(73) Assignee: InterDigital Patent Holdings, Inc., Wilmington, DE (US)

(21) Appl. No.: 19/102,753

(22) PCT Filed: Jul. 27, 2023
(86) PCT No.: PCT/US2023/071080

§ 371 Date: Feb. 10, 2025

Related U.S. Application Data
(60) Provisional application No. 63/399,759, filed on Aug. 22, 2022.

(51) Int. Cl. H04L 27/26

(52) U.S. Cl. CPC H04L 27/2602; H04L 27/26526

(57) ABSTRACT

Distributed, adaptive insertion of a reference signals (RSs) in discrete Fourier transform-spread-orthogonal frequency division multiplexing (DFT-s-OFDM) transmission schemes may comprise pre-DFT and/or post-DFT insertion of distributed RSs at locations in the frequency domain. In an example configuration, a wireless transmit/receive unit (WTRU) may determine a first codebook comprising one or more demodulation reference signal (DM-RS) sequences, receive one or more DFT-s-OFDM symbols comprising one or more DM-RS sequences, and determine set of one or more DM-RS sequences using blind detection, based on the received one or more DFT-s-OFDM symbols. This RS insertion scheme may improve overhead, provide control of peak to average power ratio (PAPR), and mitigate adverse effects on spectral efficiency.

### CROSS REFERENCE TO RELATED APPLICATIONS

This application claims the benefit of U.S. Provisional Patent Application No. 63/399,759, filed Aug. 22, 2022, which is hereby incorporated herein by reference in its entirety.

### BACKGROUND

Discrete Fourier transform-spread-orthogonal frequency division multiplexing (DFT-s-OFDM) is a single-carrier transmission scheme which may be utilized in fourth generation (4G) Long-Term Evolution (LTE) and fifth generation (5G) New Radio (NR) wireless cellular systems. A reference signal (RS) may be inserted into a DFT-s-OFDM transmission scheme to measure various characteristics of a radio channel. A reference signal (RS) may comprise multiple reference symbols which may be inserted in a DFT-s-OFDM symbol. RS insertion, however, may detrimentally affect performance. For example, RS insertion may increase peak to average power ratio (PAPR), thus worsening power amplifier efficiency. As another example, RS insertion may adversely affect spectral efficiency (e.g., the information rate that can be transmitted over a given bandwidth).

### SUMMARY

Example methods, apparatuses, and systems are described herein for distributed and adaptive insertion of a reference signal (RS), or reference signals, in discrete Fourier transform-spread-orthogonal frequency division multiplexing (DFT-s-OFDM) transmission schemes. The herein described RS insertion schemes may improve overhead and provide control of peak to average power ratio (PAPR).

A reference signal sequence may be dynamically selected by a transmitting node among a set of sequences specified in a pre-determined codebook, and interleaved with DFT pre-coded data symbols, based on PAPR measurements performed by the transmitting node.

A reference signal sequence may be dynamically selected by a transmitting node among a set of sequences specified in a pre-determined codebook. The selected reference signal sequence may be used to replace a set of DFT pre-coded symbols. The set of DFT pre-coded symbols replaced by reference symbols are said to be “punctured.” The selection of the RS sequence may be based on PAPR measurements and/or a transmitted signal (e.g., DFT pre-coded data symbol) structure.

A receiving node may detect a transmitted reference signal based on either blind detection of a sequence from one or more sequences in a pre-determined codebook, or based on explicit signaling, and may utilize the detected reference signal for channel estimation and signal equalization/decoding. Blind detection refers to the situation in which a transmitting node sends no indication of the RS sequence that it used during transmission. Thus, a receiving node may have no explicit indication of the RS sequence used by its transmitting node. As such, the receiving node may detect the transmitted reference signal sequence based on the received signal without an explicit indication. This manner of detection of the RS sequence from the received signal is referred to as blind detection. Blind detection at the receiving node may be implemented, for example, when the RS sequence is a finite part of a known bigger sequence, or part of a known code book, or a pre-determined codebook. Alternatively, a transmitting node may send an indication of its selected RS sequence to the receiving node through explicit signaling. This may facilitate RS sequence detection at the receiving node.

A padding sequence structure and a reference signal sequence may be dynamically selected by a transmitting node among a set of structures/sequences specified in pre-determined codebook(s) based on PAPR measurements and/or transmitted signal (e.g., a DFT pre-coded data symbol), structure. The padding sequence may be appended by the transmitting node to the modulated data symbols prior to the DFT stage and the reference signal sequence may be used to replace punctured samples of DFT pre-coded data+padding sequence symbols.

A receiving node may detect a transmitted reference signal based on either blind detection of a sequence from one or more sequences in a pre-determined codebook or explicit signaling, utilizing the detected reference signal for channel estimation and signal equalization, performing IDFT, detecting a padding sequence structure via blind detection or explicit signaling, and utilizing the detected sequence structure for interference cancelation and signal decoding.

An example method for inserting reference signals may comprise receiving control information indicating a set of two or more demodulation reference signal (DM-RS) sequences. One or more discrete Fourier transform-spread-orthogonal frequency division multiplexing (DFT-s-OFDM) symbols may be received, each of the one or more DFT-s-OFDM symbols comprising respective data, a respective DM-RS, or a combination thereof. Using blind detection, a first subset of DM-RS sequences based on the set of one or more DM-RS sequences may be determined, wherein determining the first subset of DM-RS sequences may be based on the received one or more DFT-s-OFDM symbols. A performance parameter associated with the first subset of DM-RS sequences may be determined. The determined performance parameter associated with the first subset of DM-RS sequences may be determined to be less than a threshold performance parameter. Based on the determination that the performance parameter associated with the first subset of DM-RS sequences is less than the threshold performance parameter, an indication of a second subset of DM-RS sequences may be sent.

Further regarding the method, the control information may comprise a codebook comprising the set of one or more DM-RS sequences. The control information may be received via a downlink control information (DCI)-related signal or a medium access control (MAC) control element (CE). The method may include determining a channel estimation based on the first subset of DM-RS sequences, wherein the performance parameter is associated with the determined channel estimation. The method may include determining DFT-s-OFDM symbol equalization based on the first subset of DM-RS sequences, wherein the performance parameter is associated with the determined DFT-s-OFDM symbol equalization. The performance parameter may comprise a decoding performance parameter. The decoding performance parameter may at least one of a block error rate (BLER) or a bit error rate (BER). The method may include receiving second control information, the second control information indicating a second subset of DM-RS sequences. The method may include receiving an additional DFT-s-OFDM symbol and processing the additional DFT-s-OFDM symbol using the second subset of DM-RS sequences. The blind detection may be based on a correlation of the indicated set of one or more DM-RS sequences with the received one or more DFT-s-OFDM symbols.

An example WTRU for inserting reference signals may include a transceiver and a processor. The processor may be configured to receive, via the transceiver, control information, the control information indicating a set of two or more demodulation reference signal (DM-RS) sequences. The processor may be configured to receive, via the transceiver, one or more discrete Fourier transform-spread-orthogonal frequency division multiplexing (DFT-s-OFDM) symbols, each of the one or more DFT-s-OFDM symbols comprising respective data, a respective DM-RS, or a combination thereof. The processor may be configured to, using blind detection, determine a first subset of DM-RS sequences based on the set of one or more DM-RS sequences, wherein the determining the first subset of DM-RS sequences is based on the received one or more DFT-s-OFDM symbols. The processor may be configured to determine a performance parameter associated with the first subset of DM-RS sequences. The processor may be configured to determine that the determined performance parameter associated with the first subset of DM-RS sequences is less than a threshold performance parameter, The processor may be configured to, based on the determination that the performance parameter associated with the first subset of DM-RS sequences is less than the threshold performance parameter, send, via the transceiver, an indication of a second subset of DM-RS sequences.

Further regarding the WTRU, the control information may comprise a codebook comprising the set of one or more DM-RS sequences. The control information may be received via a downlink control information (DCI)-related signal or a medium access control (MAC) control element (CE). The processor may be configured to determine a channel estimation based on the first subset of DM-RS sequences, wherein the performance parameter is associated with the determined channel estimation. The processor may be configured to determine DFT-s-OFDM symbol equalization based on the first subset of DM-RS sequences, wherein the performance parameter is associated with the determined DFT-s-OFDM symbol equalization. The performance parameter comprises a decoding performance parameter. The decoding performance parameter may comprise at least one of a block error rate (BLER) or a bit error rate (BER). The processor may be configured to receive, via the transceiver, second control information, the second control information indicating a second subset of DM-RS sequences. The processor may be configured to receive an additional DFT-s-OFDM symbol and process the additional DFT-s-OFDM signal using the second subset of DM-RS sequences. The blind detection may be based on a correlation of the indicated set of one or more DM-RS sequences with the received one or more DFT-s-OFDM symbols.

### BRIEF DESCRIPTION OF THE DRAWINGS

A more detailed understanding may be had from the detailed description below, given by way of example in conjunction with drawings appended hereto. Figures in such drawings, like the detailed description, are examples. As such, the Figures and the detailed description are not to be considered limiting, and other equally effective examples are possible and likely. Like reference numerals (“ref.” or “refs.”) in the Figures indicate like elements.

FIG. 1A is an example system diagram illustrating an example communications system in which one or more disclosed embodiments may be implemented.

FIG. 1B is an example system diagram illustrating an example wireless transmit/receive unit (WTRU) that may be used within the communications system illustrated in FIG. 1A according to an embodiment.

FIG. 1C is an example system diagram illustrating an example radio access network (RAN) and an example core network (CN) that may be used within the communications system illustrated in FIG. 1A according to an embodiment.

FIG. 1D is an example system diagram illustrating a further example RAN and a further example CN that may be used within the communications system illustrated in FIG. 1A according to an embodiment.

FIG. 2 depicts an example of pre-discrete Fourier transform (DFT) and post-DFT insertion of a reference signal (RS) in a DFT-spread-orthogonal frequency division multiplexing (DFT-s-OFDM) system.

FIG. 3 depicts an example of interleaved insertion of a RS in a DFT-s-OFDM system.

FIG. 4 depicts an example of insertion of a RS by subcarrier puncturing through zero-padding.

FIG. 5 is flowchart of an example process for dynamic RS insertion at the base station (BS) side.

FIG. 6 is a flowchart of an example process for data detection and cancellation of interference from RS insertion at the wireless transmit/receive unit (WTRU) side.

FIG. 7 depicts an example block diagram of the DFT-s-OFDM reception process.

FIG. 8 is a flowchart of an example process of RS insertion selection by the transmitting node aided by receiving node feedback.

FIG. 9 depicts a block diagram of an example transmitter architecture for peak to average power ratio (PAPR) reduction using an adaptive demodulation reference signal (DM-RS).

FIG. 10 depicts a block diagram of an example receiver architecture for PAPR reduction using DM-RS.

FIG. 11 is a flowchart of an example process for detection of shared DFT-s-OFDM symbols supporting DM-RS blind detection and codebook change requests.

FIG. 12 is a flowchart of an example process for detection of shared DFT-s-OFDM symbols supporting DM-RS blind detection and codebook update using assistance information.

FIG. 13 is a flowchart of an example process for detection of shared DFT-s-OFDM symbols supporting padding sequence's interference cancelation, DM-RS blind detection, and padding sequence structure and codebook change requests.

FIG. 14 is a flowchart of an example process for detection of shared DFT-s-OFDM symbols supporting padding sequence's interference cancelation, DM-RS blind detection, and dynamic selection of padding sequence structure and DM-RS codebook.

### EXAMPLE NETWORKS FOR IMPLEMENTATION OF THE INVENTION

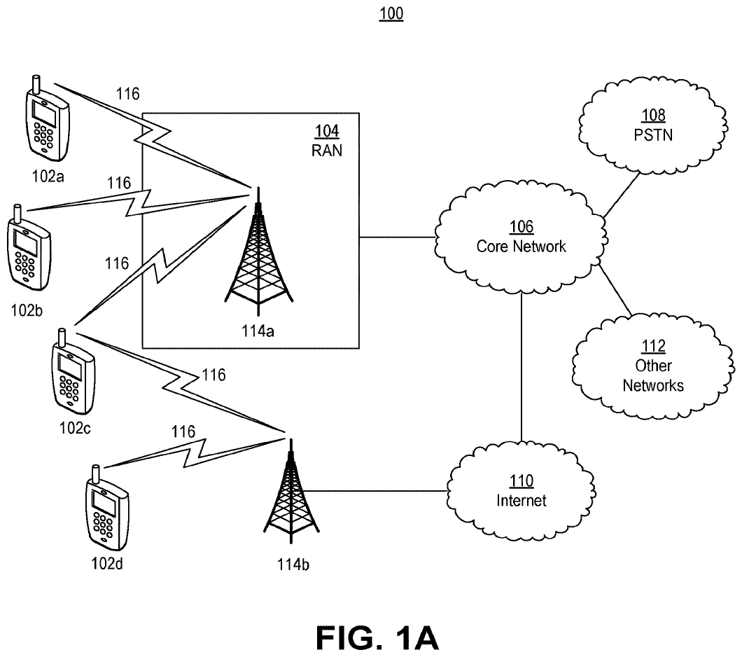

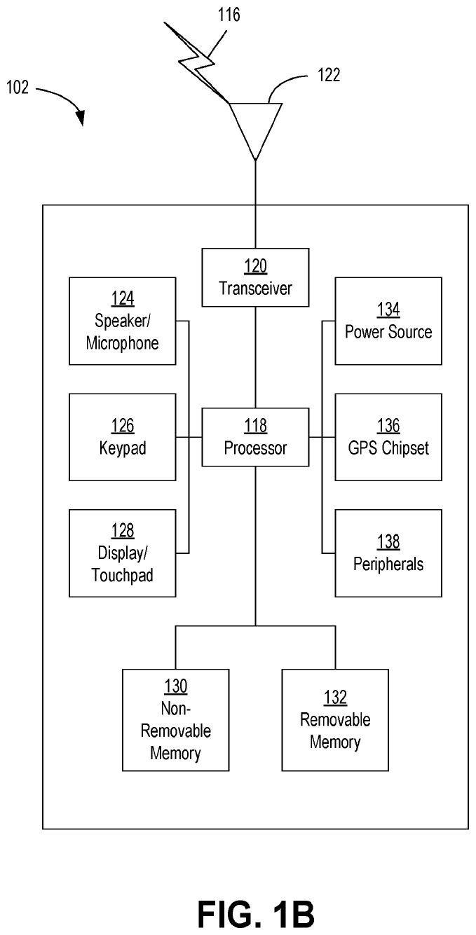

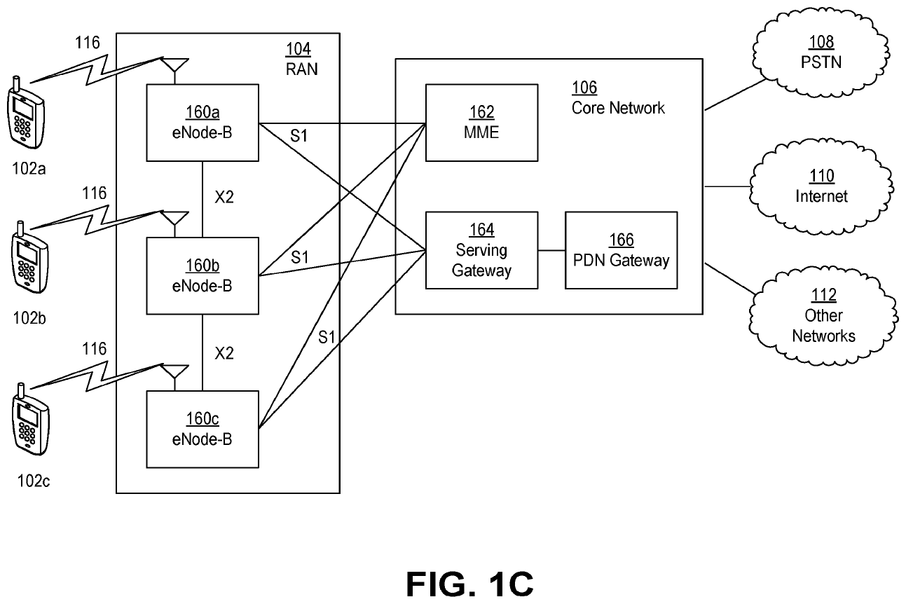

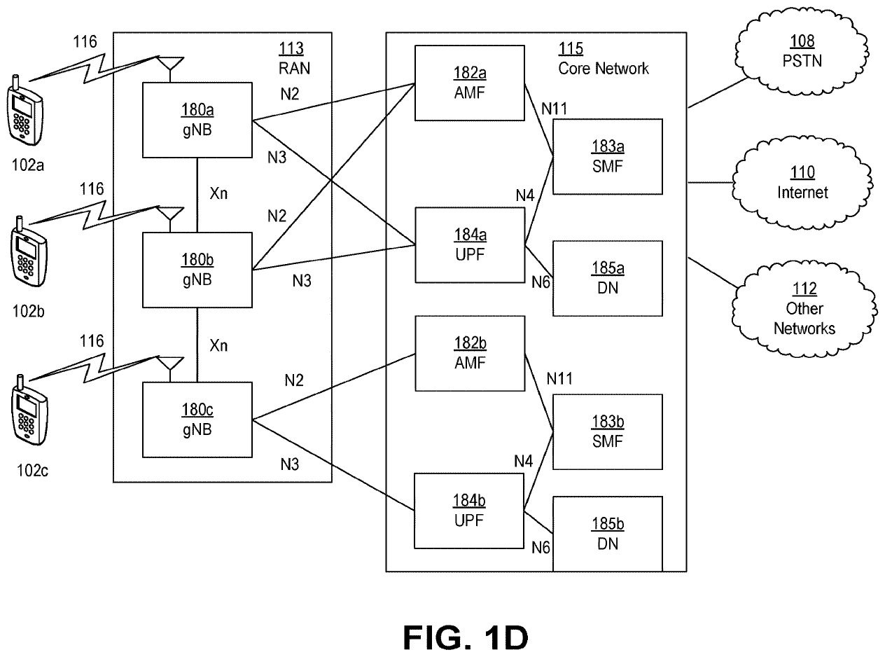

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word DFT-Spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a RAN 104/113, a CN 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106/115, the Internet 110, and/or the other networks 112. By way of example, the base stations 114a, 114b may be a base transceiver station (BTS), a Node-B, an eNode B, a Home Node B, a Home eNode B, a gNB, a NR NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 115/116/117 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed UL Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., a eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing a NR radio technology, the CN 106/115 may also be in communication with another RAN (not shown) employing a GSM, UMTS, CDMA 2000, WiMAX, E-UTRA, or WiFi radio technology.

The CN 106/115 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/113 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the UL (e.g., for transmission) and downlink (e.g., for reception) may be concurrent and/or simultaneous. The full duplex radio may include an interference management unit 139 to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the UL (e.g., for transmission) or the downlink (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (or PGW) 166. While each of the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have an access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier Sense Multiple Access with Collision Avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support Meter Type Control/Machine-Type Communications, such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 180b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (COMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 115 shown in FIG. 1D may include at least one AMF 182a, 182b, at least one UPF 184a, 184b, at least one Session Management Function (SMF) 183a, 183b, and possibly a Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different PDU sessions with different requirements), selecting a particular SMF 183a, 183b, management of the registration area, termination of NAS signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for machine type communication (MTC) access, and/or the like. The AMF 162 may provide a control plane function for switching between the RAN 113 and other RANs (not shown) that employ other radio technologies, such as LTE, LTE-A, LTE-A Pro, and/or non-3GPP (third generation partnership project) access technologies such as WiFi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-b, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

Discrete Fourier Transform-spread-Orthogonal Frequency Division Multiplexing (DFT-s-OFDM) is a single-carrier waveform adopted by Third Generation Partnership Project (3GPP) for the uplink of 4G Long-Term Evolution (LTE) and 5G New Radio (NR) wireless cellular standards. Unlike other multicarrier waveforms like Cyclic Prefix (CP)-Orthogonal Frequency Division Multiplexing (CP-OFDM), its single-carrier nature allows a reduced peak-to-average power ratio (PAPR) while retaining other benefits like DFT-based frequency-domain equalization and simple inter-symbol interference (ISI) mitigation. The efficiency of the power amplifiers (PAs) may improve with a reduced PAPR because the range of output powers where the device keeps a linear response is larger, hence delivering higher output power for the same power amplifier (PA) technology. This property is applicable, for example, when carrier frequencies are increased beyond Frequency Range 2 (FR2), e.g., above 52.6 GHZ, as PA efficiency may start to shrink dramatically at these higher frequencies.

DFT-s-OFDM may be characterized by a transform precoding stage added to the processing steps in CP-OFDM. Transform precoding may achieve a single-carrier waveform in the time domain if subcarriers are mapped to contiguous frequency positions, which may limit the flexibility of DFT-s-OFDM to allocate control and data information in the frequency domain. For this reason, control and data channels in 5G NR may not be multiplexed in frequency but allocated different DFT-s-OFDM symbols so that the single-carrier nature is preserved. This is also applicable to some 5G NR Reference Signals, like DM-RS, for example, which does not allow multiplexing of data information in the same symbol.

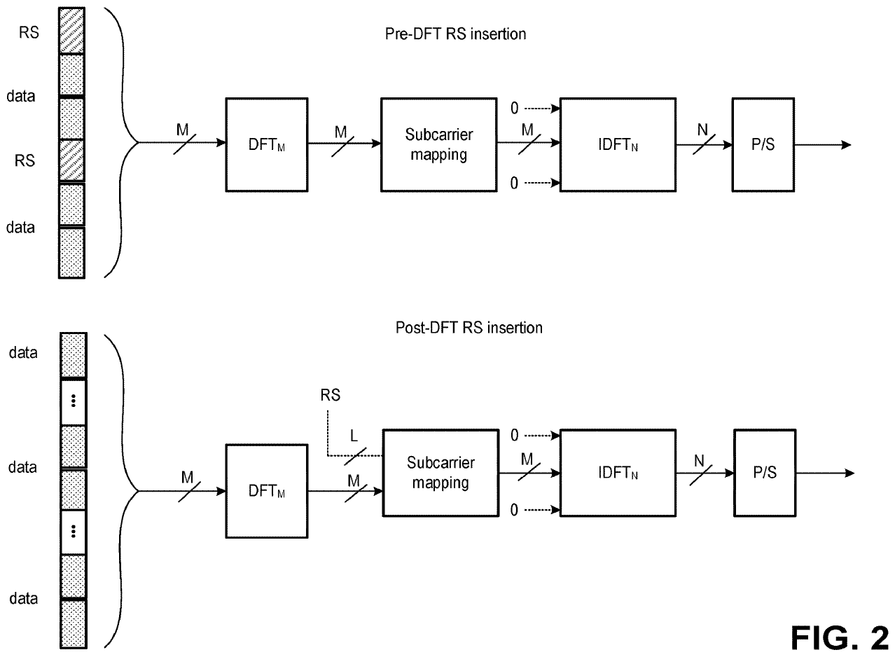

FIG. 2 depicts an example of pre-DFT and post-DFT insertion of a reference signal (RS) in a DFT-spread-orthogonal frequency division multiplexing (DFT-s-OFDM) system. Insertion of RS in DFT-s-OFDM may be categorized in either of two mechanisms: pre-DFT or post-DFT, as depicted in FIG. 2. RS insertion in 5G NR may utilize RS pre-DFT insertion. Insertion of a RS in 5G NR may be performed before the DFT stage, referred to herein as pre-DFT RS insertion. When inserted before performing a DFT, RS symbols may be multiplexed with data in the time domain or mapped alone in the symbol before transform precoding. Subcarriers may be mapped to contiguous frequency positions to preserve the single-carrier nature of the waveform. Thus, frequency-multiplexing of control and data information may not be possible. For example, 5G NR Demodulation Reference Signals (DM-RS), may be mapped alone in the symbol and occupy up to four complete symbols per slot in DFT-s-OFDM. No data information is frequency-multiplexed in those symbols, which may lead to inefficiencies from the high resource utilization of the control signals especially when more than one DM-RS symbol per slot is used. Increasing the number of DM-RS symbols beyond one might be appropriate at frequencies beyond 52.6 GHz to effectively track doppler variations at the higher modulations. In these cases, the overhead from DM-RS may be quite high.

As another example, 5G NR Phase-Tracking Reference Signals (PT-RS), may be multiplexed with data in the time domain before the DFT. Unlike DM-RS, PT-RS symbols may be multiplexed with data prior to the DFT and the resource utilization may be adjusted based on needs. However, the DFT operation spreads both data and PT-RS over the output subcarriers, and thus may not be possible to multiplex data and control information in the frequency domain. Accordingly, pre-DFT RS insertion in 5G NR may therefore be limited to the generation of either contiguous RS in the frequency domain (with poor resource utilization) or RS multiplexed with data in the time domain (not able to be interleaved with data in the frequency domain).

When inserted after DFT (referred to as post-DFT insertion), RS symbols may be multiplexed with data at whatever frequency locations are needed. The contiguous allocation of data subcarriers in the frequency domain is not preserved and PAPR may increase compared to the case with no RS inserted. However, resource efficiency may be higher than in pre-DFT insertion by allocating only the RS symbols that are needed. Two example techniques are described below for post-DFT insertion: interleaved RS insertion and subcarrier puncturing.

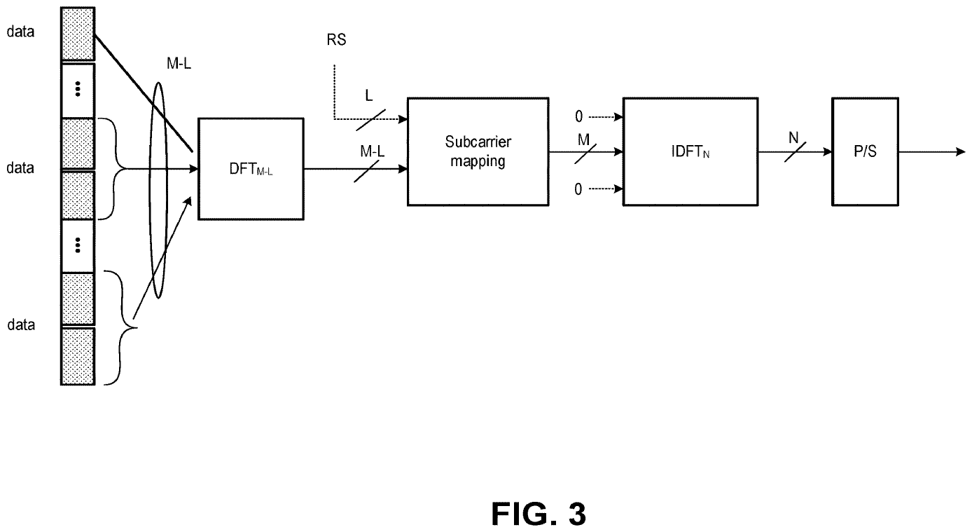

FIG. 3 depicts an example approach for post-DFT insertion using subcarriers interleaving. If L reference symbols are to be inserted in a distributed manner within a block of M contiguous subcarriers and multiplexed with (M−L) modulated data symbols, an (M−L)-point DFT may be performed over the data and its output mapped to non-contiguous frequency positions, thus leaving space for further allocation of L reference symbols in interleaved form. L reference symbols and (M−L) data symbols are in this way effectively interleaved in M subcarriers.

This procedure may be suited to the insertion of distributed RS at non-periodic locations in the frequency domain. However, it may have the disadvantage of forcing the transceiver to employ different DFT sizes for DFT-s-OFDM symbols carrying RS (M−L) and not carrying RS (M), hence complicating implementations. Moreover, both (M−L) and M must comply with the allowed DFT sizes in 3GPP LTE and NR, for example {2^{a}·3^{b}·5^{c}, a, b, c∈N}, which may limit the standards evolution towards the use of different RS frequency densities. As an example, frequency densities of one eighth of the resource elements may not be allowed for an RS signal, as

$$M - L = \frac{7}{8} M$$

does not comply with the formula regardless of the value of M. In addition, this technique may not facilitate PAPR control. The complexity, measured by the number of complex multiplications and not considering the equalization step (common to all techniques), is given by (M−L)log₂(M−L).

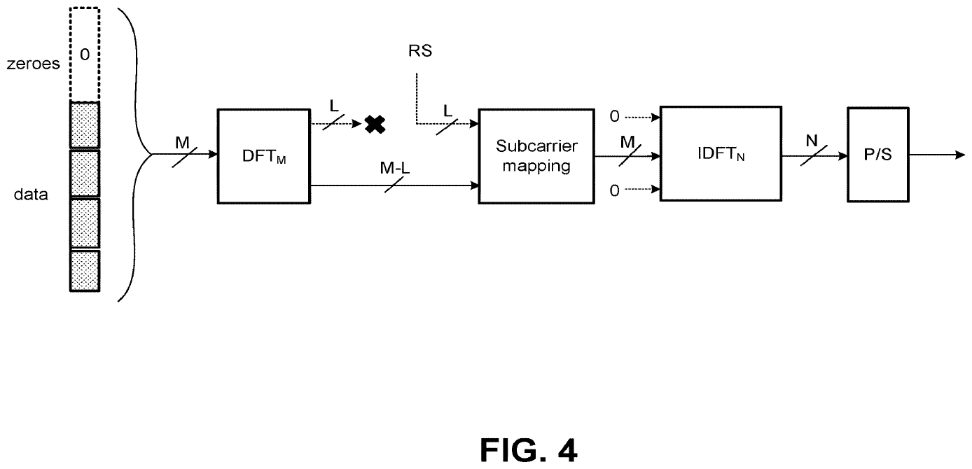

FIG. 4 depicts an example of insertion of a RS by subcarrier puncturing through zero-padding. Using the same DFT size in all DFT-s-OFDM symbols may be more appealing for post-DFT insertion of RS. An example of this is depicted in FIG. 4, wherein data symbols are padded with zeroes up to size M and an M-point DFT is performed, then L data subcarriers are punctured at the output of the DFT stage and RS signals are inserted.

This procedure may be suited to the insertion of distributed RS at periodic locations in the frequency domain. In this case, subcarrier puncturing may lead to some interference that appears in the DFT-s-OFDM time-domain signal in the form of a periodic term, as a consequence of the periodic locations of the RS subcarriers, and may be compensated at reception before demodulating the data symbols. Such interference may produce an increase in both bit error rate (BER) statistics and PAPR. The latter is added to the PAPR increase caused by RS insertion as a result of the non-contiguity of data subcarriers after DFT. PAPR increase may be unwanted in multi-user scenarios based on DFT-s-OFDM where each user is allocated a different cluster of subcarriers in the frequency domain, because the PAPR of multi-clustered transmissions may worsen with the dynamic load of the network. Techniques for post-DFT insertion based on subcarrier puncturing may rely on the receiver to perform interference mitigation for data recovery and may not provide any means to reduce PAPR.

RS insertion by subcarrier puncturing with adaptation may comprise post-DFT RS insertion techniques based on subcarrier puncturing and selection of suitable padding sequence structure(s) to append to the data symbols before the DFT stage. Various examples may be identified depending on, for example, the type of transmitting node (base station or user equipment/WTRU), the type of padding sequence adaptation (dynamic or semi-static), etc.

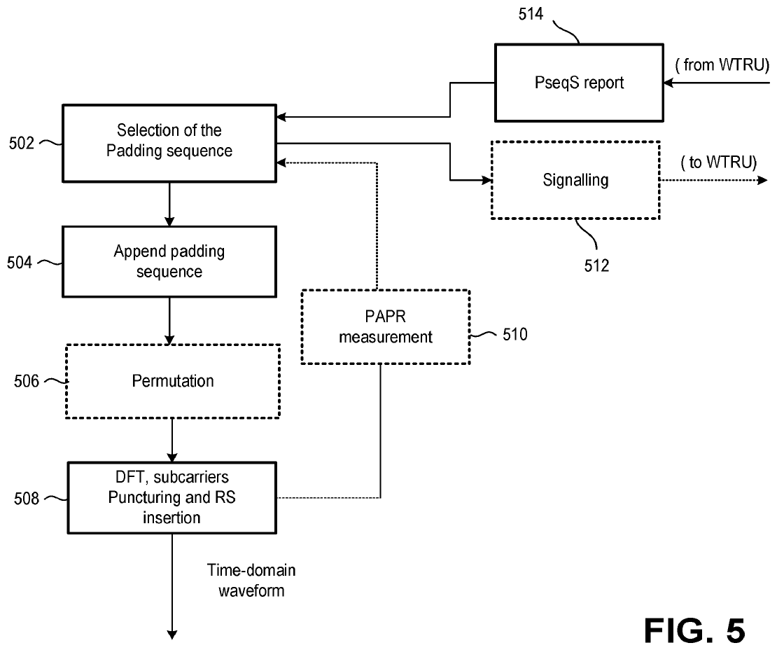

FIG. 5 is flowchart of an example process for dynamic RS insertion at the base station (BS) side. Error! Reference source not found. A base station (BS), or any appropriated network entity, may perform the following steps depicted in FIG. 5 for dynamic insertion of distributed RS. One or multiple padding sequences may be dynamically selected (502) by the BS among a set of padding sequence structures specified in a pre-determined codebook, based on, for example, PAPR measurements performed by the BS or time-domain measurements performed by the User Equipment (UE), also referred to as a wireless transmit/receive unit (WTRU), over the current symbol and/or several previous symbols, and on feedback reports sent on a periodic, semi-periodic, on-demand or event-based fashion by the WTRU. The padded sequences may be appended (504) to the modulated data symbols prior to the DFT stage. A permutation (506) may be applied over the resulting block of data and padding symbols in such a way that the complex modulated symbols after permutation are uncorrelated and the permuted positions of the padding symbols are different modulo-L from one another. An M-point DFT may be performed (508), and the subcarriers located at the target pilot positions may be punctured (508) and replaced (508) by L RS symbols (e.g., complex-valued, blank, etc.). DFT-s-OFDM processing may follow to generate the time-domain waveform and PAPR may be measured (510) to refine the padding sequence selection in subsequent time intervals. The dotted lines in FIG. 5 represent optional aspects. For example, permutation (506) may be optionally included depending on the amount of correlation. PAPR may be measured (510) and reported by the WTRU instead of measured at the BS. Signaling (512) may be absent in, e.g., blind decoding by the WTRU.

The BS may signal to the WTRU (512) the padding sequence structure(s) used by means of one or multiple padding sequence structure identifier (PSeqS ID) fields, which may be sent once during session establishment and/or dynamically updated during data transfer, or alternatively the sequence identifier(s) may be blindly detected by the WTRU without the need for explicit signaling. Where multiple transmission/reception points (TRP) may be used to transmit the data channel, e.g., with different or same transport blocks, different or same redundancy versions of the same transport block, or different or same code words, etc., using the fully/partially/non-overlapped time-frequency resources for example using different DL beams, the BS may send multiple PSeqS ID fields, or a combined PSeqS ID field, to the WTRU containing indications about the padding sequence structure(s) to be used for each TRP. A feedback report optionally may be sent to the BS containing PSeqS reports (514) in a periodic, semi-periodic or on-demand fashion to aid in the padding sequence selection process, as well as eventual time-domain reporting messages containing time-domain measurements performed by the WTRU.

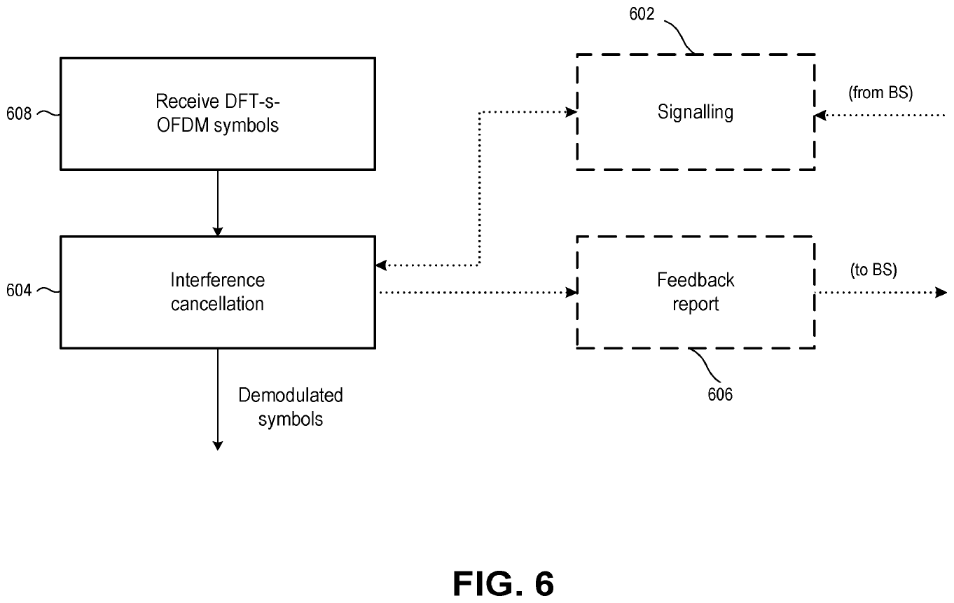

FIG. 6 is a flowchart of an example process for data detection and cancellation of interference from RS insertion at the wireless transmit/receive unit (WTRU) side. As depicted in FIG. 6, the WTRU, or any appropriate entity, may perform the following steps for interference cancellation, caused, e.g., by subcarrier puncturing and RS insertion, and recovery of the data. The WTRU may obtain periodic signaling information (602) from the BS, or any appropriate network entity, containing the padding sequence structure(s) used among the sequence structures contained in a pre-determined codebook. Alternatively, the WTRU may know the sequence structure(s) in advance or perform blind detection of the padding sequence structure(s) without the need for explicit signaling. DFT-s-OFDM symbols may be received (608) containing complex modulated data symbols affected by interference caused by subcarrier puncturing. Interference may be cancelled (604) and the complex modulated symbols may be estimated and delivered to the higher layers. A feedback report (606) optionally may be sent to the BS containing PSeqS reports in a periodic, semi-periodic or on-demand fashion to aid in the padding sequence selection process, as well as eventual time-domain reporting messages containing time-domain measurements performed by the WTRU.

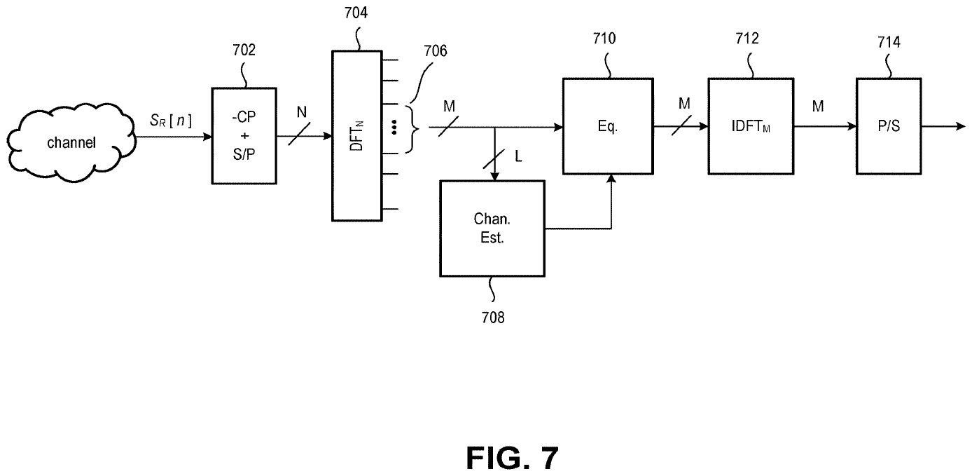

FIG. 7 depicts an example block diagram of the DFT-s-OFDM reception process. The DFT-s-OFDM symbol reception and interference cancelation processing steps are further detailed below, with reference to FIG. 7. Regarding receipt of DFT-s-OFDM symbols, DFT-s-OFDM processing may take the time-domain received waveform s_{R} [n] and deliver the data symbols affected by interference from subcarrier puncturing. FIG. 7 depicts the processing blocks comprising at least CP removal (702), serial/parallel conversion (702), N-point DFT (704), extraction of the subcarriers allocated to the user (706), channel estimation (708), equalization (710), M-point inverse DFT (712), and parallel/serial conversion (714). Additional processing blocks may be possible depending on the implementation.

Cancellation of the interference introduced in the subcarrier puncturing process at the BS side may be performed. The WTRU may exploit the presence of the padding sequence to help estimate and further remove the interference term from the time-domain symbols prior to demodulation. Any suitable detection strategy may serve, including successive interference cancellation (SIC), maximum-likelihood (ML) detector, or the like, an any appropriate combination thereof.

To illustrate this point, subcarrier puncturing and RS insertion following a pattern

$$\{ k \frac{M}{L} + p , k = 0 , ... , L - 1 \}$$

yields an interference term that contains an L-periodical term p[m] in the time domain, frequency-shifted by p [6]:

$$p [ m ] {e}^{\frac{j 2 π pm}{M}} .$$

The DFT of p[m] is equal to the RS symbols inserted minus the values of the punctured subcarriers. The receiver can thus exploit this term to estimate the interference with the aid of the padding symbols c[m] appended to the data after properly undoing the permutation step and the frequency shift p.

Distributed RS patterns inserted in the frequency domain present several advantages compared to block RS patterns. Distributed RS patterns may have higher efficiency of resource utilization compared to the block RS patterns in pre-DFT RS insertion, as evident in 5G NR DM-RS for PUCCH Format 3 with an overhead up to 50%. Distributed RS may bring more flexibility than block RS to allocate Multiple Input/Multiple Output (MIMO) orthogonal layers. In Multi-User (MU)-MIMO, the use of hybrid beamforming at high frequencies may require digital precoding to spatially multiplex the signals when beams overlap in space. In Single-User (SU)-MIMO, future device evolution might lead to an increased number of supported MIMO layers. In both cases, DM-RS signals can be more flexibly mapped to resources when allocated in the frequency domain.

Systems using DFT-s-OFDM only may contemplate pre-DFT insertion of RS based on either occupying a full OFDM symbol resource allocation (with poor resource utilization) or multiplexing with data signals in the time domain (not able to be interleaved with data in the frequency domain), in order not to impair the single carrier waveform's low PAPR. Post-DFT insertion of RS as an alternative solution may avoid the spectral inefficiencies associated with the use of pre-DFT insertion of RS.

Post-DFT insertion based on interleaved RS insertion may have disadvantages, such as, increased PAPR, restrictions in the attainable RS frequency patterns, and use of different DFT sizes for symbols carrying and not carrying RS. RS insertion by subcarrier puncturing, when accomplished through zero padding, may not provide an ability to control PAPR and performance other than through optimized receiver structures.

Described herein is an adaptive framework for pre-DFT and/or post-DFT insertion of distributed RS in DFT-s-OFDM at periodic locations in the frequency domain, that provides flexibility of RS frequency patterns while providing means to minimize PAPR and optimize demodulation performance. Additionally, WTRU assistance, for example, in terms of WTRU capability signaling and measurements are described.

In the subsequent embodiments it will be assumed that L reference symbols (or pilots) are to be inserted in a distributed manner over a block of M contiguous subcarriers and multiplexed with (M−L) modulated data symbols {d[0], . . . , d[M−L−1]}. Pilots may be a-priori known complex values or blank symbols depending on the application.

Pilots may be inserted at regularly spaced subcarrier positions

$$\{ k \frac{M}{L} + p , k = 0 , ... , L - 1 \} ,$$

where p can be any integer of the set

$$p ∈ \{ 0 , ... , \frac{M}{L} - 1 \}$$

and represents an a-priori known frequency shift. Combined frequency patterns are also possible in the form

$$\{ {k}_{1} \frac{M}{L} + {p}_{1} , {k}_{1} = 0 , ... , L - 1 \} , \{ {k}_{2} \frac{M}{L} + {p}_{2} , {k}_{2} = 0 , ... , L - 1 \}$$

with two a-priori known frequency shifts p₁,

$${p}_{2} ∈ \{ 0 , ... , \frac{M}{L} - 1 \} \cdot ( M - L )$$

will be a multiple of L.

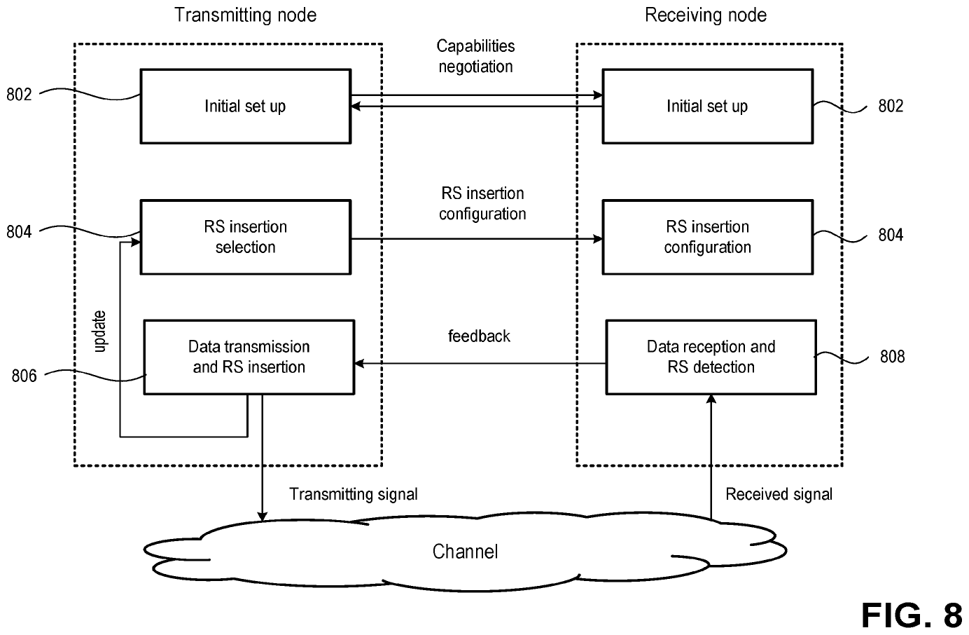

FIG. 8 depicts a flow chart containing procedures for RS insertion in DFT-s-OFDM signals. More specifically, FIG. 8 depicts an example process of RS insertion selection by a transmitting node utilizing receiving node feedback. A transmitting node and a receiving node may first exchange some information (802) containing, without limitation, any of the following elements related with their RS insertion capabilities: Support of pre-DFT RS insertion; Support of post-DFT RS insertion based on interleaved frequency division multiple access (IFDMA); Support of RS insertion based on subcarrier puncturing via padding sequences, and the supported padding sequence structures; Support of fixed or adaptive RS sequences, the RS sequences supported in the adaptive case; Power amplifier (PA)-related information, like e.g., PA type/class or Peak to Average Power Ratio (PAPR) requirement/preference; Demodulation-related information, like e.g., support of SIC with a maximum number of iterations, or any other detection-related parameter; or the like, or any appropriate combination thereof.

The transmitting node may provide the receiving node with RS insertion configuration parameters (804) via e.g., downlink control information (DCI)-related signaling, MAC CE (control element), or higher layer signaling. RS insertion configuration parameters may comprise, RS insertion type, padding sequence structure detection mode (blind vs. explicit), padding sequence structure identifier, RS codebook identifier(s), any other information required by the RS insertion technique, or the like, or any appropriate combination thereof. RS insertion type may be dynamically selected among any of the following: pre-DFT RS insertion of full RS symbols, pre-DFT RS insertion based on IFDMA, post-DFT RS insertion based on padding sequence adaptation, post-DFT RS insertion with RS sequence adaptation, post-DFT RS insertion based on padding sequence adaptation and RS sequence adaptation, or the like, or any appropriate combination thereof. The transmitting node may decide to switch among these alternatives based on available transmit power, PAPR, complexity, and/or on feedback reports or signaling information obtained from the receiving node containing, among others, information about demodulation performance, PAPR measurements, capabilities information, preferred RS insertion type, preferred padding sequence structure type, or a similar indication, or the like, or any appropriate combination thereof.

After data transmission and RS insertion (806), the receiver may perform data reception and provide feedback (808) in an event, triggered or periodic fashion in order to aid the transmitting node in the selection of the most suitable RS insertion technique to use for that node.

The transmitting node also may dynamically update some or all of the configuration parameters related with RS insertion as a response to the receiving node's feedback, such as padding sequence structure identifier, RS sequence type, RS codebook, or the like, or any appropriate combination thereof.

Pre-DFT RS insertion of full RS symbols, pre-DFT RS insertion based on IFDMA, and post-DFT RS insertion based on padding sequence adaptation may be performed. Post-DFT RS insertion with RS sequence adaptation and post-DFT RS insertion based on padding sequence adaptation and RS sequence adaptation techniques are described in the following sections, with exemplary embodiments.

Examples embodiments to reduce the resource overhead associated with RS while providing the flexibility to control PAPR are described. The example embodiments consider post-DFT RS insertion techniques based on either subcarrier interleaving or puncturing along with dynamic adaptation of the selected RS sequence to control PAPR.

The RS, e.g., DM-RS, may be adapted to the transmitted data within the shared DFT-s-OFDM symbol(s) based on instantaneous or statistical evaluation of the impact of RS insertion on the overall transmitted signal's PAPR. The RS sequence may be selected from one or more RS sequences in a defined codebook based on, for example, any of the following.

The RS sequence may be selected based on a search over the codebook elements to determine the sequence that minimizes the PAPR of the transmitted signal based on data symbols to be transmitted within current DFT-s-OFDM symbol, slot, sub-frame, etc.

The RS sequence may be selected based on search over the codebook elements to determine the sequence that minimizes the average PAPR of the transmitted signal(s) based on data symbols transmitted over prior one or more DFT-s-OFDM symbol(s), slot(s), sub-frame(s), etc.

The RS sequence may be selected based on search over the codebook elements to determine the sequence that minimizes the average PAPR of the transmitted signal(s) based on data symbols transmitted over current and prior one or more DFT-s-OFDM symbol(s), slot(s), sub-frame(s), etc.

The RS sequence may be selected based on a minimization of the distance, e.g., determined by inner product, to a vector of the same length as the RS and determined by applying DFT to a known structure of the data symbols (to be transmitted within any of current DFT-s-OFDM symbol, slot, and sub-frame) and selecting the DFT output at the subcarriers allocated for the RS.

The RS sequence may be selected based on a minimization of the distance, e.g., determined by inner product, to a vector of the same length as the RS and determined by applying DFT to a known structure of the data symbols (transmitted over prior one or more DFT-s-OFDM symbol(s), slot(s), or sub-frame(s) and selecting the DFT output at the subcarriers allocated for the RS.

The RS sequence may be selected based on a minimization of the distance, e.g., determined by inner product, to a vector of the same length as the RS and determined by applying DFT to a known structure of the data symbols (transmitted over current and prior one or more DFT-s-OFDM symbol(s), slot(s), or sub-frame(s) and selecting the DFT output at the subcarriers allocated for the RS.

When the size of the utilized DFT is the sum of the data symbols set size and RS sequence length, the known structure of the data symbols may be, for example, a cyclic-prefixed structure wherein the set of data symbols are appended by a repetition of a subset of the data symbols, a sign-reversed structure wherein the set of data symbols are appended by a sign-reversed repetition of a subset of the data symbols, a phase-shifts structure wherein the set of data symbols are appended by repetition of a phase-shifted subset of the data symbols, a sequence-padded structure wherein the set of data symbols are appended by one or more sequence(s) of constant-envelope characteristics, a zero-padded structure wherein the set of data symbols are appended by zeroes up to the length of the sum of the data symbols set size and RS sequence length, or the like, or any appropriate combination thereof.

The RS sequence also may be selected from the one or more RS sequences in a defined codebook taking into account the level of interference across data symbols that may be caused by RS insertion in frequency domain using the subcarrier puncturing approach/technique.

The set of one or more RS sequence(s) in one or more RS codebook(s), may comprise any of, for example, a set of pseudo-random sequences or a set of Zadoff-Chu sequences or a set of any other low-PAPR sequences or a combination of thereof, which may be determined according to, for example, any one or more of the following.

The set of one or more RS sequence(s) may be determined based on a set of initializing seeds that depend on the codebook size, N_{cb}, and are related to each other by a fixed offset, O_{cb}, obtained as L1/MAC-CE/RRC (radio resource control) signaling or as pre-configuration. For example, the initializing seed of the n^{th} RS sequence c_{init,n}=c_{init,n-1}+O_{cb}, n∈{1, 2, . . . . N_{cb}−1}.

The set of one or more RS sequence(s) may be determined based on a set of initializing seeds that are related to an initial seed by a set of L1/MAC-CE/RRC signaled (or preconfigured) fixed offsets, O_{cb,n}, as c_{init,n}=c_{init,n-1}+O_{cb,n}, n∈{1, 2, . . . . N_{cb}−1}.

The set of one or more RS sequence(s) may be determined based on a set of initializing seeds that depend on the codebook size, N_{cb}, and are related to each other by a varying offset. For example, the initializing seed of the n^{th} RS sequence c_{init,n}=c_{init,0}+ƒ(n), n∈{1, 2, . . . . N_{cb}−1} for a function ƒ(·) which may be, for example, linear, quadratic, parabolic, . . . etc.

The set of one or more RS sequence(s) may be determined based on a set of one or more parameterized base/root sequence(s), e.g., identified using parameters pᵢ where i∈{0, 1, . . . , nᵣₛ−1}, each with a corresponding one or more cyclic shift(s), e.g., α_{l,i} where l∈{0,1, . . . , n_{cs,i}−1}, such that the total number of sequences is limited by the codebook size, i.e., Σᵢ n_{cs,i}=N_{cb}. A sequence p_{l,i}[n] may be constructed from a base/root sequence pᵢ[n] as p_{l,i}[n]=pᵢ[(n−α_{l,i})mod L], where mod denotes the modulus operator and L denotes the length of the sequence. The set of root sequence(s) parameters and cyclic shift values {pᵢ,α_{l,i}} may be preconfigured or signaled via L1, MAC-CE, and/or radio resource control (RRC) messages.

The one or more initializing seed(s) and/or offset(s) and/or cyclic shifts may further depend, for example, on any one or more of the following: an OFDM symbol number where the RS is transmitted, the number of symbols per slot, the serving cell ID, one or more signaled/configured scrambling IDs, and a code division multiplexing (CDM) group. Additionally, a known transformation, e.g., Discrete Fourier Transform (DFT), may be applied to one or more of the RS sequence(s) after generation. Further, one or more elements in each RS sequence within the book may be scaled by one or more scaling factors that may be common across the one or more elements or unique for individual or group of elements across the one or more elements. The scaling factor(s), and mapping to elements, may be pre-specified/configured or signaled and should ensure the conformance with the specified RS transmission power.

The RS codebook may be adapted/updated dynamically or semi-statically based on one or more of the following: the distribution(s) of the channel parameters, the distribution of the transmitted/received data, incurred signaling overhead, and receiver capability. The distribution of the transmitted/received data can be inferred directly at the transmitting entity without a need for feedback from the receiving entity whereas the distribution(s) of channel parameter(s) may require feedback or assistance from the receiving entity to be acquired at the transmitting entity. Adaptation the RS codebook, either its size or the relationship between the sequences within the codebook, may be due to the experienced channel estimation quality at the receiver, especially in case of blind RS detection. The adaptation may also be required to limit the power consumption at the receiver by reducing the RS codebook size to limit the number of blind detections at the expense of a potentially higher PAPR at the transmitter.

RS adaptation to the transmitter being configured to signal the RS codebook generation parameter(s) to the receiving entity or assist the receiving entity in determining the RS sequence that is utilized by the transmitting entity to limit blind detection complexity.

Therefore, the signaling overhead may be dependent on any of the RS codebook size and receiving entity capability in terms of blind detection. A trade-off between signaling overhead, dynamic channel conditions, and receiver capability may be considered by allowing the transmitting entity to split RS codebook(s) of large size(s) into sub-sets and dynamically signal indication(s) of the considered sub-set(s) to the receiving entity to reduce the blind detection complexity with a manageable signaling overhead. Further, signaling overhead associated with RS codebook generation parameter(s) may be reduced by limiting the generation parameter(s) to known sets at the receiver and allowing the transmitter to signal only an index to one of the known sets instead of explicit signaling of the parameters. Alternatively, a combination of explicit signaling of the RS codebook generation parameter(s) and indexed signaling may be considered.

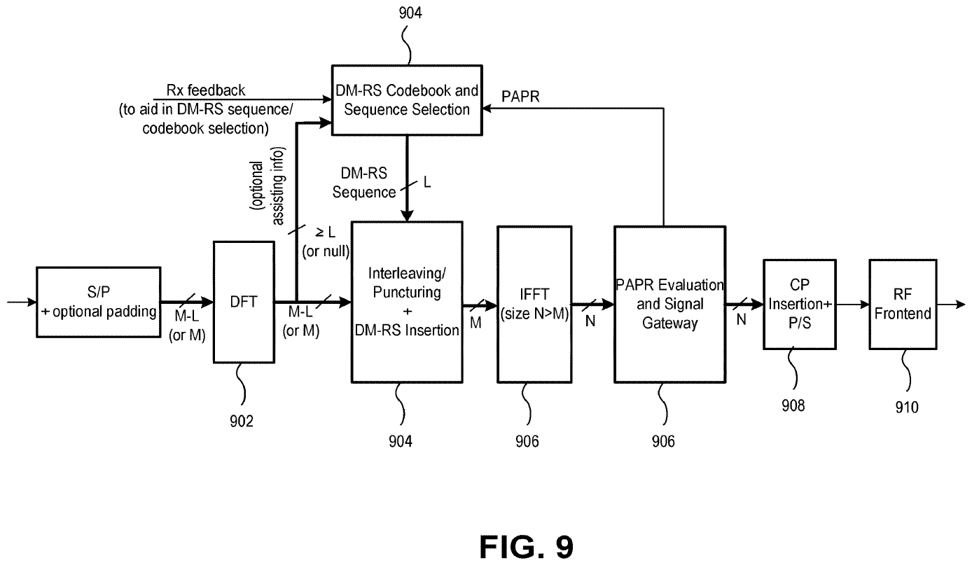

FIG. 9 depicts an example transmitter architecture employing dynamic insertion of distributed RS, e.g., DM-RS, to adjust PAPR. The transmitting entity, e.g., BS, may perform the following steps to generate a signal with low PAPR characteristics. At step 902, an (M−L)-point DFT may be performed on (M−L) data symbols and the output of the DFT may be interleaved leaving L empty samples for RS insertion. At step 904, a RS, e.g., DM-RS, of length L may be selected from a RS codebook, by the RS codebook and sequence selection module, and interleaved with the (M−L) data symbols using the L empty samples. At step 906, an N-point IFFT may be performed on the data and RS symbols and PAPR may be evaluated, at the output of the IFFT module, and fed back to the RS codebook and sequence selection module. At step 908, a cyclic prefix (CP) may be appended to the DFT-s-OFDM symbol and the signal may be provided to the RF front end for transmission over the channel at step 910.

In an alternative to step 902, the transmitting entity may perform an (M)-point DFT on (M−L) data symbols that are padded with L zero symbols and the output of the DFT is punctured replacing L output samples with L empty samples for RS insertion.

In another alternative to step 902, the transmitting entity may perform an (M)-point DFT on (M−L) data symbols that are padded with L cyclically prefixed symbols and the output of the DFT is punctured replacing L output samples with L empty samples for RS insertion.

In an additional alternative to step 902, the transmitting entity may perform an (M)-point DFT on (M−L) data symbols that are padded with L symbols corresponding to a constant envelope sequence and the output of the DFT is punctured replacing L output samples with L empty samples for RS insertion. The constant envelope sequence may be selected randomly from a set of known sequences or selected to satisfy a criterion, e.g., minimum PAPR at the input of the DFT module.

In an additional alternative to step 902, the transmitting entity may perform an (M)-point DFT on (M−L) data symbols that are padded with L symbols corresponding to a sign-reversed or phase-shifted replica of a subset of the data symbols, and the output of the DFT is punctured replacing L output samples with L empty samples for RS insertion. The phase shift may be selected to satisfy a criterion, e.g., minimum PAPR at the input of the DFT module.

In one alternative to step 906, the PAPR evaluation feedback may be considered for the ongoing/current transmission where the second and third steps are repeated for a certain number of times utilizing different RSs at each iteration before the final selection of the RS to be utilized for the actual transmission by proceeding to the fourth step.

In another alternative to step 906, the PAPR evaluation feedback may be considered for subsequent transmission where the RS selection in the second step considers the evaluated PAPR history. In this alternative, the RS codebook and sequence selection module may instead consider the PAPR evaluated and fed back by the receiving node.

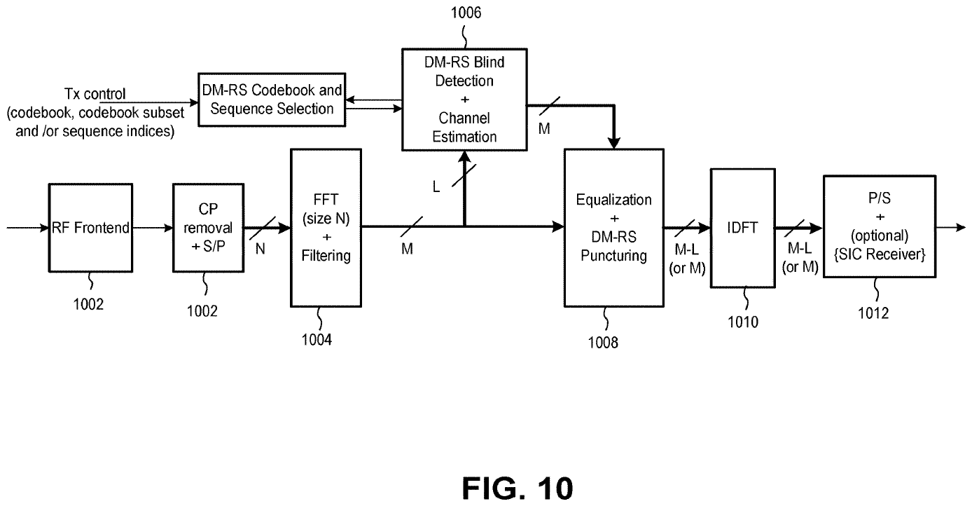

FIG. 10 depicts an example receiver architecture employing dynamic/adaptive detection of distributed RS, e.g., DM-RS. The receiving entity, e.g., a WTRU, may perform the following steps to receive a signal with adaptive RS, e.g., DM-RS, characteristics. At step 1002, a DFT-s-OFDM signal/symbol comprising data and RS, e.g., DM-RS, may be received from the RF front end and cyclic prefix (CP) samples may be removed during serial to parallel conversion. At step 1004, an N-point FFT may be performed on the CP-stripped DFT-s-OFDM symbols, the L symbols corresponding to the RS may be delivered to the RS detection module, and (M−L) data symbols are delivered to the equalization module. At step 1006, the RS detection module may determine a RS sequence from a list of RS sequences in a codebook using blind detection, may estimate the channel using the determined RS, and may deliver an (M−L) channel estimation vector to the equalization module. At step 1008, the equalization module may reverse the impact of the channel on (M−L) data symbols and may deliver the (M−L) equalized symbols to the IDFT module 1010. At step 1012, the P/S and receiver module may receive the output of the IDFT module and performs symbol demodulation, decoding, and bit detection.

In one alternative to step 1004, the (M−L) data symbols and the L RS symbols may both be delivered to the equalization module and an M equalized symbols are generated after proper identification of the RS used and proper channel estimation by the RS detection module. An M-point IDFT is then performed on the M equalized symbols and the P/S and receiver module extracts the (M−L) data symbols from the M samples at the output of the IDFT module.

In one example, the (M−L) data symbols may be extracted from the M samples at the output of the IDFT module by simply discarding the L-padded symbols that were appended to the data symbols during transmission. In another example, the structure of the padded symbols, e.g., zeros or constant envelop sequences, may be used for the estimation of the interference, e.g., caused by subcarrier puncturing for RS insertion, i.e., at the transmitter, and cancellation as described in Section 2.3.3 (ii) for better decoding performance.

The codebook used for RS sequence detection in the third step may be, in one option, static and preconfigured at the WTRU. In a second option, it may be configurable and selected from one or more preconfigured codebooks at the WTRU using indices/indications signaled from the network as a DCI in a PDCCH or a higher layer message such as a dedicated RRC message or through system information. In a third option, the sequences constituting a codebook may be explicitly signaled to the UE from the network using higher layer messages such as dedicated RRC messages or system information.

In addition to the process described above, the WTRU may periodically evaluate performance in terms of block error rate (BLER) and/or channel estimation quality to determine the need to update the codebook used for the blind detection of the RS sequence and channel estimation. Upon determination of a performance metric below a certain threshold, which may be preconfigured or signaled to the WTRU in a configuration message, the UE may transmit a request to update the RS codebook. The request may indicate a specific codebook or may only indicate a value for the performance metric.

In an example embodiment, the WTRU may determine a DM-RS codebook in a first step based on a received indication from the network, e.g., in a DCI transmitted over PDCCH. In a second step, the WTRU may receive a DFT-s-OFDM signal/symbol comprising data and DM-RS symbols. In a third step, the WTRU may select a DM-RS sequence from one or more DM-RS sequences in the determined codebook using blind detection. The selected DM-RS sequence may be the one that has a maximum correlation with the received DM-RS sequence. In a fourth step, the WTRU may utilize the selected DM-RS sequence to estimate the channel and equalize the received DFT-s-OFDM signal/symbol. In a fifth step, the WTRU may demodulate and decode the equalized DFT-s-OFDM signal and evaluate the decoding and/or channel estimation performance. On a condition that the decoding performance falls below a certain threshold, the WTRU may transmit a request to update the DM-RS codebook.

In another example embodiment, the WTRU may determine a DM-RS codebook in a first step based on a received indication from the network, e.g., through system information. In a second step, the WTRU may receive DFT-s-OFDM signals/symbols comprising data and DM-RS symbols over one or more slots or subframes. In a third step, the WTRU may select an ordered set of one or more DM-RS sequences from the one or more DM-RS sequences in the determined codebook using blind detection. The selected DM-RS sequences are the ones that have a maximum correlation with the received one or more DM-RS sequences over the one or more slots/subframes. In a fourth step, the WTRU may utilize the selected DM-RS sequences to estimate the channel and equalize the received DFT-s-OFDM signals/symbols. In a fifth step, the WTRU demodulate and decodes the equalized DFT-s-OFDM signals/symbols and evaluates the decoding and/or channel estimation performance. In a sixth step, the WTRU may transmit feedback information including an indication of the determined channel estimation performance and an indication of the determined ordered set of one or more DM-RS sequences. Alternatively, the WTRU may transmit an indication of only a subset of the ordered set of one or more DM-RS sequences. In a seventh step, the WTRU may receive a DCI over PDCCH including an indication of a new DM-RS codebook.

In another example embodiment, the WTRU may determine a DM-RS codebook and a padding sequence structure in a first step based on a received indication from the network, e.g., through system information. In a second step, the WTRU may receive a DFT-s-OFDM signal/symbol comprising Padded data and DM-RS symbols. In a third step, the WTRU may select a DM-RS sequence from one or more DM-RS sequences in the determined codebook using blind detection. In a fourth step, the WTRU may utilize the selected DM-RS sequence to estimate the channel and equalize the received DFT-s-OFDM signal/symbol. In a fifth step, the WTRU may perform IDFT on the equalized DFT-s-OFDM signal and utilizes the determined padding sequence structure to cancel interference in the data symbols from subcarrier puncturing and DM-RS insertion at the transmitter. In a sixth step, the WTRU may demodulate and decode the equalized DFT-s-OFDM signals/symbols after interference cancellation and evaluates the decoding and/or channel estimation performance. On a first condition that the decoding performance falls below a first threshold, the UE transmits a request to update the DM-RS codebook. On a second condition that the decoding performance falls below a second threshold, the WTRU may transmit a request to update the padding sequence structure. In one alternative, the first threshold and the second threshold are the same threshold. In another alternative, the first condition is dependent on the channel estimation performance. In another technical realization of the sixth step, the WTRU may evaluate an interference leakage metric, e.g., a measurement of the interference leakage from the subcarrier puncturing and DM-RS insertion to the data symbols, and channel estimation quality. On a first condition that the interference leakage is above a first threshold and the channel estimation quality is above a second threshold, the WTRU may transmit a request to deactivate pre-DFT sequence padding. On a second condition that the interference leakage is above a first threshold and the channel estimation quality is below a second threshold, the UE transmits a request to deactivate DM-RS sequence adaptation, i.e., only a static and known DM-RS sequence is transmitted with the data symbols without a need for blind detection at the WTRU. On a third condition that the interference leakage is below a first threshold and the channel estimation quality is below a second threshold, the WTRU may transmit a request to update the DM-RS codebook. Otherwise, the WTRU may continue considering the determined DM-RS codebook and the padding sequence structure.

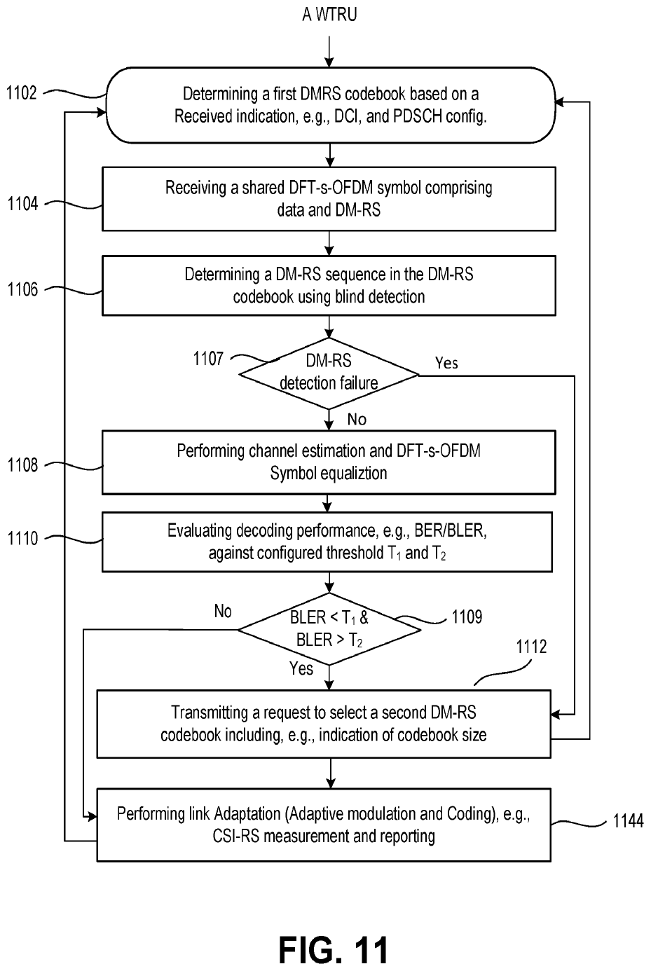

FIG. 11 is a flowchart of an example process for detection of shared DFT-s-OFDM symbols supporting DM-RS blind detection and codebook change requests. As depicted in FIG. 11, a WTRU configured to receive shared DFT-s-OFDM symbols between data and a reference signal (RS) may perform the following. At step 1102, the WTRU may determine a first codebook comprising one or more DM-RS sequences based on a received indication, e.g., a DCI in a PDCCH message. At step 1104, the WTRU may receive a DFT-s-OFDM symbol comprising data and DM-RS. At step 1106, the WTRU may determine a DM-RS sequence from the one or more DM-RS sequences in the first codebook using blind detection. At step 1107, the WTRU may determine a failure in the attempt to blindly detect the DM-RS sequence used. At step 1108, the WTRU may utilize the determined DM-RS sequence for channel estimation and DFT-s-OFDM symbol equalization. At step 1110, the WTRU may determine decoding performance, e.g., block error rate (BLER), and compare it with a first threshold and a second threshold. At step 1109, the WTRU may determine that the decoding performance, e.g., block error rate (BLER), is below a first threshold and above a second threshold. At step 1112, the WTRU may transmit a request to select a second DM-RS codebook. At step 1144, the WTRU may perform link adaptation by, e.g., measuring and reporting the channel state with the aid of CSI-RS.

The initial/first DM-RS codebook may be a default codebook indicated using a higher layer message, e.g., dedicated RRC or Sys. Info. Blind detection of the DM-RS sequence may be based on the output of the correlation of a received sequence with one or more DM-RS sequences within an indicated DM-RS codebook. The received sequence may be obtained by the extraction of symbols on a periodic allocation over subcarriers at the output of an FFT module. The determination of a DM-RS sequence may be based on blind detection and a received indication of a subset of the one or more DM-RS sequences in the default codebook. The determination of a DM-RS sequence may be based on an explicit signaling of the sequence from the transmitting node. The request to select a new DM-RS codebook may include any of an indication of channel estimation quality, a DM-RS codebook size, experienced PAPR, and blind detection capability, e.g., number of sequences to be simultaneously correlated. The first threshold may indicate a requirement to update the DM-RS codebook and the second threshold indicates a requirement to update a modulation and coding scheme.

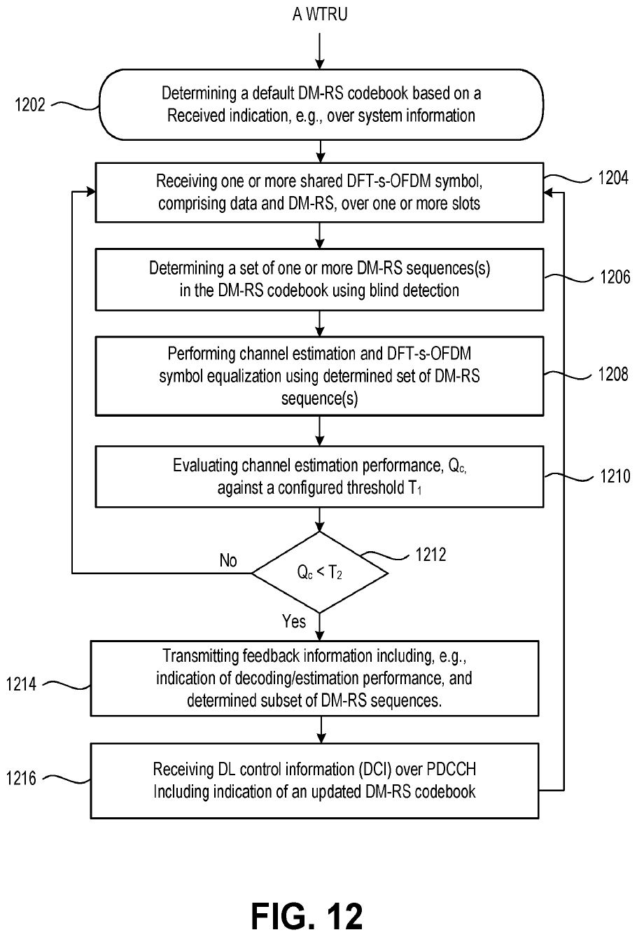

FIG. 12 is a flowchart of an example process for detection of shared DFT-s-OFDM symbols supporting DM-RS blind detection and codebook update using assistance information. As depicted in FIG. 12, a WTRU configured to receive shared DFT-s-OFDM symbols between data and demodulation reference signal (DM-RS) and provide assistance information to the serving base station may perform the following. At step 1202, the WTRU may determine any of default and first codebook comprising one or more DM-RS sequences based on a received indication, e.g., system information or DL control information. At step 1204, the WTRU may receive one or more DFT-s-OFDM symbols comprising data and DM-RS over one or more slots. At step 1206, the WTRU may determine a set of one or more DM-RS sequences, based on the received one or more DFT-s-OFDM symbols, from the one or more DM-RS sequences in any of the default and first codebook using blind detection. At step 1208, the WTRU may utilize the determined DM-RS sequence(s) for channel estimation and DFT-s-OFDM symbol equalization. At step 1210, the WTRU may determine channel estimation performance, based on the determined set of one or more DM-RS sequences, and compare it with a threshold. At step 1212, the WTRU may determine that the channel estimation performance is below a threshold. At step 1214, the WTRU may transmit feedback information including an indication of the determined channel estimation performance and an indication of any of the determined set or sub-set of the one or more DM-RS sequences. At step 1216, the WTRU may receive DL control information including an indication of a second DM-RS codebook.

Blind detection of the DM-RS sequence may be based on the output of the correlation of a received sequence with one or more DM-RS sequences within an indicated DM-RS codebook. The received sequence may be obtained by the extraction of symbols on a periodic allocation over subcarriers at the output of an FFT module. The determination of a DM-RS sequence may be based on blind detection and a received indication of a subset of the one or more DM-RS sequences in any of the default and first codebook. The sub-set of the one or more DM-RS sequences may be determined based on the failure to decode the associated physical data shared channel (PDSCH), e.g., from the gNB. Channel estimation performance may be determined based on detected correlation peaks across one or more DM-RS sequences in the DM-RS codebook.

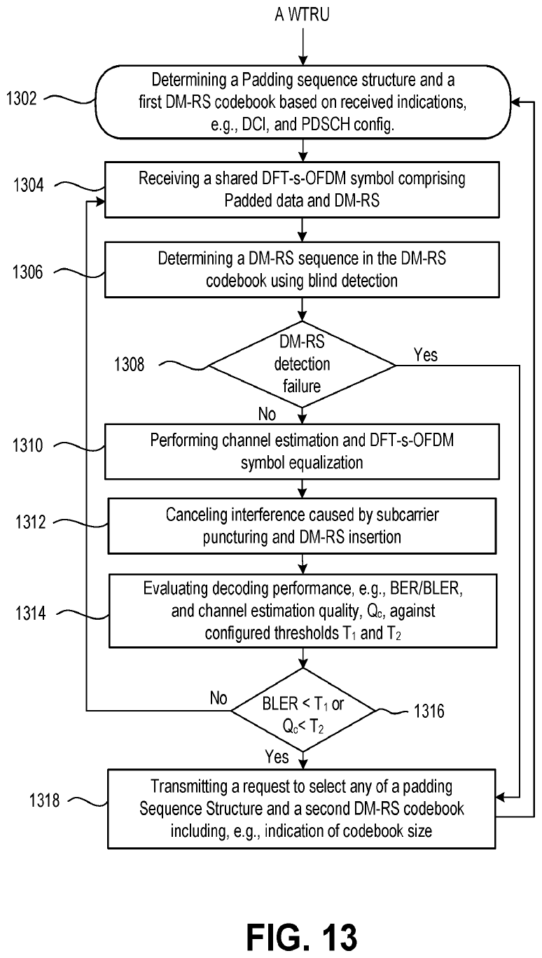

FIG. 13 is a flowchart of an example process for detection of shared DFT-s-OFDM symbols supporting padding sequence's interference cancelation, DM-RS blind detection, and padding sequence structure and codebook change requests. Post-DFT RS insertion with padding and RS sequence adaptation may be performed. As depicted in FIG. 13, a WTRU configured to receive shared DFT-s-OFDM symbols between padded data symbols and demodulation reference signal (DM-RS) may perform the following. At step 1302, the WTRU may determine a pre-DFT-Padding sequence structure and a first codebook comprising one or more DM-RS sequences based on received indications through, e.g., a DCI in a PDCCH message. At step 1304, the WTRU may receive a DFT-s-OFDM symbol comprising padded data and DM-RS. At step 1306, the WTRU may determine a DM-RS sequence from the one or more DM-RS sequences in the first codebook using blind detection. At step 1308, the WTRU may determine a failure in the attempt to blindly detect the DM-RS sequence used. At step 1310, the WTRU may utilize the determined DM-RS sequence for channel estimation and DFT-s-OFDM symbol equalization. At step 1312, the WTRU may cancel interference from DM-RS puncturing/insertion based on the determined pre-DFT-Padding sequence structure. At step 1314, the WTRU may determine any of a decoding performance, e.g., BLER, against a first threshold, and a channel estimation quality against a second threshold. At step 1316, the WTRU may determine that the decoding performance, e.g., BLER, is below a first threshold and the channel estimation quality is above a second threshold. At step 1318, the WTRU may transmit a request to update/select any of the DM-RS codebook and the pre-DFT-padding sequence structure.

Any of a pre-DFT sequence structure and an initial/first DM-RS codebook may be determined by default based on an indication received in a dedicated RRC or through system information. The determination of a DM-RS sequence may be based on blind detection and a received indication of a subset of the one or more DM-RS sequences in the default/first codebook. The transmitted request may include any of an indication of channel estimation quality, a DM-RS codebook size, experienced PAPR, and blind detection capability, e.g., number of sequences to be simultaneously correlated.

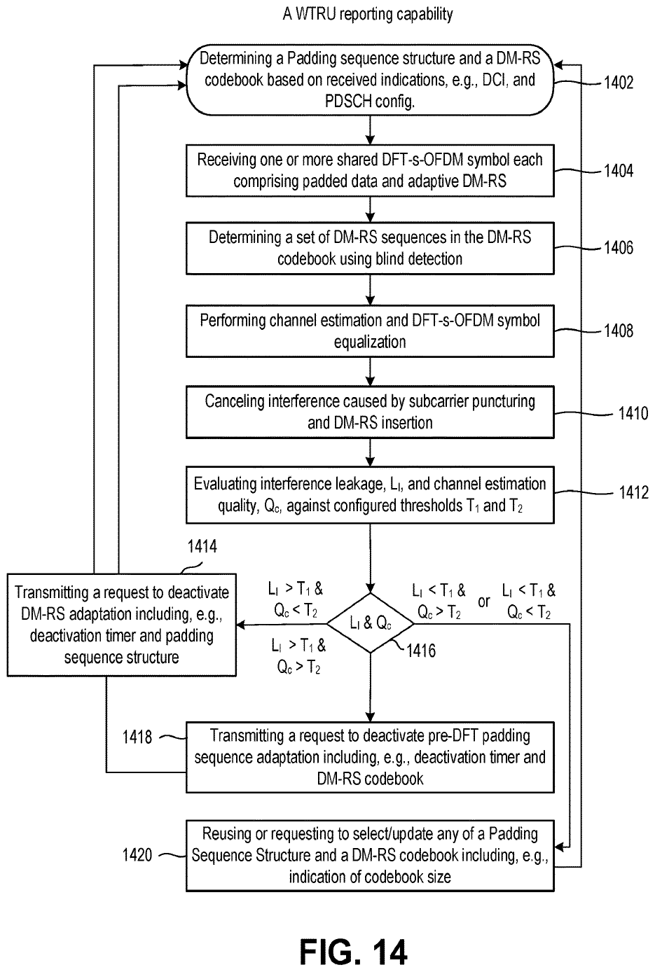

FIG. 14 is a flowchart of an example process for detection of shared DFT-s-OFDM symbols supporting padding sequence's interference cancelation, DM-RS blind detection, and dynamic selection of padding sequence structure and DM-RS codebook. As depicted inf FIG. 14, a WTRU, or any appropriate entity, configured to receive shared DFT-s-OFDM symbols between (padded) data symbols and (adaptive) demodulation reference signal (DM-RS) may perform the following. At step 1402, the WTRU may report support of interference cancelation (e.g., due to subcarrier puncturing and DM-RS insertion, and blind DM-RS sequence detection). At step 1404, the WTRU may determine a pre-DFT-Padding sequence structure and a default codebook consisting of one or more DM-RS sequences based on received indications through, e.g., system information or DL control information; receiving one or more DFT-s-OFDM symbols comprising padded data and adaptive DM-RS over one or more slots. At step 1406, the WTRU may determine a set of one or more DM-RS sequences, based on the received one or more DFT-s-OFDM symbols, from the one or more DM-RS sequences in the default codebook using blind detection. At step 1408, the WTRU, may utilize the determined DM-RS sequence(s) for channel estimation and DFT-s-OFDM symbol equalization. At step 1410, the WTRU may cancel interference from subcarrier puncturing and DM-RS insertion based on the determined pre-DFT-Padding sequence structure. At step 1412, the WTRU may determine interference leakage against a first threshold and channel estimation quality against a second threshold. At step 1416, the WTRU may determine the interference quality above a threshold and the channel estimation quality below another threshold; or the interference quality above a threshold and the channel estimation quality above another threshold; or the interference leakage below a threshold. At step 1414, the WTRU may transmit a request to deactivate DM-RS adaptation. At step 1418, the WTRU may transmit a request to deactivate pre-DFT sequence padding.

Any of a pre-DFT sequence structure and an initial/first DM-RS codebook may be determined by default based on an indication received in a dedicated RRC or through system information. The determination of a DM-RS sequence may be based on blind detection and a received indication of a subset of the one or more DM-RS sequences in the default/first codebook. The transmitted request may include any of an indication of channel estimation quality, a DM-RS codebook size, experienced PAPR, and blind detection capability, e.g., number of sequences to be simultaneously correlated. The transmitted request may be to deactivate DM-RS adaptation upon determination of an interference leakage above a first threshold and channel estimation quality below a second threshold. The transmitted request may be to select/update a second DM-RS codebook upon determination of an interference leakage below a first threshold and channel estimation quality below a second threshold. The WTRU may continue using the determined padding sequence structure and DM-RS codebook upon determination of an interference leakage below a first threshold and channel estimation quality above a second threshold.

Although features and elements are provided above in particular combinations, one of ordinary skill in the art will appreciate that each feature or element can be used alone or in any combination with the other features and elements. The present disclosure is not to be limited in terms of the particular embodiments described in this application, which are intended as illustrations of various aspects. Many modifications and variations may be made without departing from its spirit and scope, as will be apparent to those skilled in the art. No element, act, or instruction used in the description of the present application should be construed as critical or essential to the invention unless explicitly provided as such. Functionally equivalent methods, apparatuses, and articles of manufacture, within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods or systems.

Although foregoing embodiments may be discussed, for simplicity, with regard to specific terminology and structure, (e.g., radio frequency (RF), microwave, centimeter wave, micrometer wave, infrared (IR), ultraviolet (UV), visible light, etc.), the embodiments discussed, however, are not limited to thereto, and may be applied to other systems that use other forms of electromagnetic waves or non-electromagnetic waves such as acoustic waves, for example.

It is also to be understood that the terminology used herein is for the purpose of describing particular embodiments only, and is not intended to be limiting. As used herein, the term “video” or the term “imagery” may mean any of a snapshot, single image and/or multiple images displayed over a time basis, or the like, or any appropriate combination thereof. As another example, when referred to herein, the terms “user equipment” and its abbreviation “UE”, the term “remote” and/or the terms “head mounted display” or its abbreviation “HMD” may mean or include (i) a wireless transmit and/or receive unit (WTRU); (ii) any of a number of embodiments of a WTRU; (iii) a wireless-capable and/or wired-capable (e.g., tetherable) device configured with, inter alia, some or all structures and functionality of a WTRU; (iii) a wireless-capable and/or wired-capable device configured with less than all structures and functionality of a WTRU; or (iv) the like. Details of an example WTRU, which may be representative of any WTRU recited herein, are provided herein with respect to FIGS. 1A-1D. As another example, various disclosed embodiments herein supra and infra are described as utilizing a head mounted display. Those skilled in the art will recognize that a device other than the head mounted display may be utilized and some or all of the disclosure and various disclosed embodiments can be modified accordingly without undue experimentation. Examples of such other device may include a drone or other device configured to stream information for providing the adapted reality experience.

In addition, methods provided herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media, which are differentiated from signals, include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

Variations of methods, apparatuses, articles of manufacture, and systems provided above are possible without departing from the scope of the invention. In view of the wide variety of embodiments that can be applied, it should be understood that the illustrated embodiments are examples only, and should not be taken as limiting the scope of the following claims. For instance, embodiments provided herein include handheld devices, which may include or be utilized with any appropriate voltage source, such as a battery or the like, providing any appropriate voltage.

Moreover, in embodiments provided herein, processing platforms, computing systems, controllers, and other devices containing processors are noted. These devices may contain at least one Central Processing Unit (“CPU”) and memory. In accordance with the practices of persons skilled in the art of computer programming, reference to acts and symbolic representations of operations or instructions may be performed by the various CPUs and memories. Such acts and operations or instructions may be referred to as being “executed,” “computer executed” or “CPU executed.”

One of ordinary skill in the art will appreciate that the acts and symbolically represented operations or instructions include the manipulation of electrical signals by the CPU. An electrical system represents data bits that can cause a resulting transformation or reduction of the electrical signals and the maintenance of data bits at memory locations in a memory system to thereby reconfigure or otherwise alter the CPU's operation, as well as other processing of signals. The memory locations where data bits are maintained are physical locations that have particular electrical, magnetic, optical, or organic properties corresponding to or representative of the data bits. It should be understood that the embodiments are not limited to the above-mentioned platforms or CPUs and that other platforms and CPUs may support the provided methods.

The data bits may also be maintained on a computer readable medium including magnetic disks, optical disks, and any other volatile (e.g., Random Access Memory (RAM) or non-volatile (e.g., Read-Only Memory (ROM)) mass storage system readable by the CPU. The computer readable medium may include cooperating or interconnected computer readable medium, which exist exclusively on the processing system or are distributed among multiple interconnected processing systems that may be local or remote to the processing system. It should be understood that the embodiments are not limited to the above-mentioned memories and that other platforms and memories may support the provided methods.

In an illustrative embodiment, any of the operations, processes, etc. described herein may be implemented as computer-readable instructions stored on a computer-readable medium. The computer-readable instructions may be executed by a processor of a mobile unit, a network element, and/or any other computing device.

The foregoing detailed description has set forth various embodiments of the devices and/or processes via the use of block diagrams, flowcharts, and/or examples. Insofar as such block diagrams, flowcharts, and/or examples contain one or more functions and/or operations, it will be understood by those within the art that each function and/or operation within such block diagrams, flowcharts, or examples may be implemented, individually and/or collectively, by a wide range of hardware, software, firmware, or virtually any combination thereof. In example embodiments, several portions of the subject matter described herein may be implemented via Application Specific Integrated Circuits (ASICs), Field Programmable Gate Arrays (FPGAs), digital signal processors (DSPs), and/or other integrated formats. Those skilled in the art will recognize that some aspects of the embodiments disclosed herein, in whole or in part, may be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure. Those skilled in the art will appreciate that the mechanisms of the subject matter described herein may be distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a floppy disk, a hard disk drive, a CD, a DVD, a digital tape, a computer memory, etc., and a transmission type medium such as a digital and/or an analog communication medium (e.g., a fiber optic cable, a waveguide, a wired communications link, a wireless communication link, etc.).

Those skilled in the art will recognize that it is common within the art to describe devices and/or processes in the fashion set forth herein, and thereafter use engineering practices to integrate such described devices and/or processes into data processing systems. That is, at least a portion of the devices and/or processes described herein may be integrated into a data processing system via a reasonable amount of experimentation. Those having skill in the art will recognize that a typical data processing system may generally include one or more of a system unit housing, a video display device, a memory such as volatile and non-volatile memory, processors such as microprocessors and digital signal processors, computational entities such as operating systems, drivers, graphical user interfaces, and applications programs, one or more interaction devices, such as a touch pad or screen, and/or control systems including feedback loops and control motors (e.g., feedback for sensing position and/or velocity, control motors for moving and/or adjusting components and/or quantities). A typical data processing system may be implemented utilizing any suitable commercially available components, such as those typically found in data computing/communication and/or network computing/communication systems.

The herein described subject matter sometimes illustrates different components contained within, or connected with, different other components. It is to be understood that such depicted architectures are merely examples, and that in fact many other architectures may be implemented which achieve the same functionality. In a conceptual sense, any arrangement of components to achieve the same functionality is effectively “associated” such that the desired functionality may be achieved. Hence, any two components herein combined to achieve a particular functionality may be seen as “associated with” each other such that the desired functionality is achieved, irrespective of architectures or intermedial components. Likewise, any two components so associated may also be viewed as being “operably connected”, or “operably coupled”, to each other to achieve the desired functionality, and any two components capable of being so associated may also be viewed as being “operably couplable” to each other to achieve the desired functionality. Specific examples of operably couplable include but are not limited to physically mateable and/or physically interacting components and/or wirelessly interactable and/or wirelessly interacting components and/or logically interacting and/or logically interactable components.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, where only one item is intended, the term “single” or similar language may be used. As an aid to understanding, the following appended claims and/or the descriptions herein may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”). The same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.” Further, the terms “any of” followed by a listing of a plurality of items and/or a plurality of categories of items, as used herein, are intended to include “any of,” “any combination of,” “any multiple of,” and/or “any combination of multiples of” the items and/or the categories of items, individually or in conjunction with other items and/or other categories of items. Moreover, as used herein, the term “set” is intended to include any number of items, including zero. Additionally, as used herein, the term “number” is intended to include any number, including zero. And the term “multiple”, as used herein, is intended to be synonymous with “a plurality”.

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein may be readily broken down into a lower third, middle third and upper third, etc. As will also be understood by one skilled in the art all language such as “up to,” “at least,” “greater than,” “less than,” and the like includes the number recited and refers to ranges which can be subsequently broken down into subranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

What is claimed is:

1-22. (canceled)

23. A wireless transmit/receive unit (WTRU) comprising:
a transceiver; and
a processor configured to:
receive, via the transceiver, control information, wherein the control information comprises an indication of one or more demodulation reference signal (DM-RS) sequences;
determine a codebook based on the received one or more DM-RS sequences;
receive, via the transceiver, one or more discrete Fourier transform-spread-orthogonal frequency division multiplexing (DFT-s-OFDM) symbols;
using blind detection, determine a subset of the one or more DM-RS sequences based on the received one or more DFT-s-OFDM symbols;
determine that at least one of:
a decoding performance parameter associated with the subset of the DM-RS sequences is less than a first threshold; or
a channel estimation quality associated with the subset of the DM-RS sequences is less than a second threshold;
determine that an interference leakage metric is above a third threshold; and
send, via the transceiver, a request to update the codebook based on the determined interference leakage metric and based on at least one of the determined decoding performance parameter or the channel estimation quality.

24. The WTRU of claim 23, wherein the interference leakage metric is based on interference leakage from subcarrier puncturing and DM-RS insertion.

25. The WTRU of claim 23, wherein the processor is further configured to perform DFT-s-OFDM symbol equalization based on the subset of DM-RS sequences.

26. The WTRU of claim 23, wherein the processor is further configured to:
receive an updated codebook; and
demodulate and decode a DFT-s-OFDM signal based on the updated codebook.

27. The WTRU of claim 23, wherein the blind detection is based on a correlation of a received DM-RS sequence with one or more DM-RS sequences within an indicated DM-RS codebook.

28. The WTRU of claim 27, wherein the received DM-RS sequence is determined by extraction of symbols on a periodic allocation over subcarriers at an output of an FFT module.

29. The WTRU of claim 23, wherein the processor is configured to receive, via the transceiver, the control information via a downlink control information (DCI)-related signal or a medium access control (MAC) control element (CE).

30. The WTRU of claim 23, wherein the processor is further configured to receive, via the transceiver, second control information, the second control information indicating a second subset of DM-RS sequences.

31. The WTRU of claim 30, wherein the processor is further configured to:
receive an additional DFT-s-OFDM symbol; and
process the additional DFT-s-OFDM symbol using the second subset of DM-RS sequences.

32. The WTRU of claim 23, wherein the processor is further configured to determine a second subset of DM-RS sequences based on a failure to decode a physical data shared channel (PDSCH).

33. A method performed by a wireless transmit/receive unit (WTRU), the method comprising:
receiving control information, wherein the control information comprises an indication of one or more demodulation reference signal (DM-RS) sequences;
determining a codebook based on the received one or more DM-RS sequences;
receiving one or more discrete Fourier transform-spread-orthogonal frequency division multiplexing (DFT-s-OFDM) symbols;
using blind detection, determining a subset of the one or more DM-RS sequences based on the received one or more DFT-s-OFDM symbols;
determining that at least one of:
a decoding performance parameter associated with the subset of the DM-RS sequences is less than a first threshold; or
a channel estimation quality associated with the subset of the DM-RS sequences is less than a second threshold;
determining that an interference leakage metric is above a third threshold; and
sending a request to update the codebook based on the determined interference leakage metric and based on at least one of the determined decoding performance parameter or the channel estimation quality.

34. The method of claim 33, wherein the interference leakage metric is based on interference leakage from subcarrier puncturing and DM-RS insertion.

35. The method of claim 33, further comprising performing DFT-s-OFDM symbol equalization based on the subset of DM-RS sequences.

36. The method of claim 33, further comprising:
receiving an updated codebook; and
demodulating and decoding a DFT-s-OFDM signal based on the updated codebook.

37. The method of claim 33, wherein the blind detection is based on a correlation of a received DM-RS sequence with one or more DM-RS sequences within an indicated DM-RS codebook.

38. The method of claim 37, wherein the received DM-RS sequence is determined by extraction of symbols on a periodic allocation over subcarriers at an output of an FFT module.

39. The method of claim 33, further comprising receiving the control information via a downlink control information (DCI)-related signal or a medium access control (MAC) control element (CE).

40. The method of claim 33, further comprising receiving second control information, the second control information indicating a second subset of DM-RS sequences.

41. The method of claim 40, further comprising:
receiving an additional DFT-s-OFDM symbol; and
processing the additional DFT-s-OFDM symbol using the second subset of DM-RS sequences.

42. The method of claim 33, further comprising determining a second subset of DM-RS sequences based on a failure to decode a physical data shared channel (PDSCH).
